(19) United States
(12) Patent Application Publication
(10) Pub. No.: US 2023/0365219 A1
(43) Pub. Date: Nov. 16, 2023

(54) Axle With Clone Clamping System

(71) Applicant: Canyon Bicycles GmbH, Koblenz (DE)

(72) Inventor: Johannes Thumm, Lörrach (DE)

(21) Appl. No.: 18/195,075

(22) Filed: May 9, 2023

(30) Foreign Application Priority Data
May 10, 2022 (DE) 20 2022 102 547.9

(51) Int. Cl. B62K 25/02; B60B 35/04; B60B 35/00

(52) U.S. Cl. CPC B62K 25/02; B60B 35/04; B60B 35/004; B62K 2206/00

(57) ABSTRACT

A quick-release axle system includes two bicycle elements, particular two chain stays. They are connected to each other by means of a quick-release axle. Two clamping elements are provided for the connection, so that a non-positive connection is realized between the two bicycle elements and the quick-release axle.

### CROSS-REFERENCE TO RELATED APPLICATION

This application claims priority to German Patent Application No. 20 2022 102 547.9 filed May 10, 2022, the disclosure of which is hereby incorporated by reference in its entirety.

### BACKGROUND OF THE INVENTION

### Field of the Invention

The invention relates to a quick-release axle system. Such quick-release axle systems can be used to pivotally connect bicycle elements such as chain stays, rocker stays or the like to a bicycle frame.

Such quick-release axle systems are configured to pivotally connect a bicycle rear frame via a main link bearing to the bicycle frame. Usually, the quick-release axle system is arranged in the area of the bottom bracket on the frame. In particular, the two chain stays are held pivotally on the frame. In quick-release axle systems, a quick-release axle is provided which is inserted through a corresponding opening on the bicycle frame element. Furthermore, two bearings usually designed as ball bearings are arranged in this area. Since the two chain stays always have to move uniformly, in such known quick-release axle systems the two chain stays are connected to each other via a chain stay bridge. Said bridge is arranged in the area of the quick-release axle, i.e. close to the frame. The two chain stays thus form a rigid component together with the chain stay bridge and are thus connected to each other in a torsionally rigid manner. However, the bridge required for rigid connection has the disadvantage that the required space is large. This is a particular disadvantage in the case of bicycles with electric motor drive, as the installation space for the arrangement of a center motor in this area is thus limited.

### Description of Related Art

From DE 20 2018 002 931 a quick-release axle is known in which no chain stay bridge is provided. In order to still realize a torsionally rigid connection of the two chain stays, a positive connection of the two chain stays via a gearing is additionally provided in the area of the quick-release axle. Although this can eliminate the need for a chain stay bridge, this system has the disadvantage that it is a complex system and the gearing is cost-intensive, especially in production. Furthermore, irrespective of the gearings, it has to be ensured that the axial bearing clearance of the two main link bearings can be adjusted.

Suspended bicycle rear frames also comprise saddle stays in addition to the chain stays, which are articulated and in particular connected to the bicycle frame. The saddle stays are connected to a rocker element in an articulated or pivoting manner. The rocker element is in turn pivotally connected to the frame. Furthermore, the rocker element is connected directly or indirectly to a damping element at the end opposite the saddle stays. Such rocker elements are usually composed of two components, so-called rocker stays, with the two rocker stays usually arranged to the side of the frame's saddle tube. Since the rocker stays or the rocker element have to transmit considerable forces, they are connected to each other in particular on the rear side of the saddle tube, i.e. on the side facing the rear wheel. Similar to the connection of chain stays, this has the disadvantage that a corresponding space has to be provided for this.

### SUMMARY OF THE INVENTION

It is an object of the invention to create a quick-release axle system with which a space-saving connection of two pivotally interconnected bicycle elements is realized in a simple manner.

According to the invention, the object is achieved by a quick-release axle system having the features as described herein.

The quick-release axle system is configured for the pivoting connection of two bicycle elements. In particular, this is a pivoting connection of the two chain stays to a bicycle frame element. Furthermore, the quick-release axle system according to the invention is in particular the pivoting connection of two rocker stays to a bicycle frame element, in particular the saddle tube of the bicycle frame. Accordingly, a quick-release axle system according to the invention can also be used to pivotally interconnect other bicycle elements in a space-saving manner, the invention being described below by way of example using the connection of the two chain stays to the bicycle frame.

The quick-release axle system according to the invention comprises a quick-release axle which is configured to connect two bicycle elements, in particular indirectly. In particular, the invention of the two chain stays is effected via the quick-release axle, so that the two chain stays are pivotally connected to the bicycle frame. According to the invention, a clamping element is arranged between each of the bicycle elements, i.e. in particular each of the chain stays and the quick-release axle. According to the invention, the clamping element is configured such that a non-positive connection of the two bicycle elements, i.e. the two chain stays, to the quick-release axle is realized. The non-positive connection between the chain stays and the quick-release axle thus provides a rigid, in particular torsionally rigid connection between the two chain stays via the quick-release axle. In this respect, a chain stay bridge can be omitted or at least configured to be significantly smaller and thus more space-saving. Due to the provision of clamping elements, the assembly as well as the manufacture is simple and cost-effective.

Preferably, an adjustment element displaceable at least in the axial direction of the quick-release axles is connected to the quick-release axle. The clamping force can be adjusted by axially displacing or moving the adjustment element. Preferably, the adjustment element can also be used for axially preloading the two bearing elements or for adjusting the bearing elements, so that no separate adjustment of the bearing elements is required. This is particularly advantageous if the bearing elements are ball bearings.

In a preferred embodiment, the at least one adjustment element is axially displaced such that the adjustment element is designed as a screw or has an extension provided with a thread. Thus, the axial displacement of the adjustment element is performed by turning. Preferably, the quick-release axle has an opening into which the screw or the threaded extension is screwed. In particular, this is a middle central opening of the quick-release axle.

It is possible to provide an adjustment element on both sides of the quick-release axle, in particular in the form of a screw, so that a very fine adjustment of the clamping force for the clamping connection of the quick-release axle with the two chain stays and, if provided, a simultaneous adjustment of the bearings is possible.

In a simplified embodiment, only one adjustment element is provided. In this embodiment, the quick-release axle is preferably configured such that on the side of quick-release axle opposite the adjustment element, the quick-release axle has an extension which is in particular head-shaped or ring-shaped. In a preferred embodiment, said extension can be integrally formed with the quick-release axle. Here, the head-shaped extension is arranged in particular on an outer side of the chain stay. Accordingly, a head-shaped extension of the adjustment element, which is in particular in the form of a screw, is also arranged on the outer side of the opposite chain stay. When the adjustment element is screwed in, the two, in particular head-shaped extensions thus move towards each other and effect a clamping connection of the two chain stays to the quick-release axle via the clamping elements provided according to the invention.

For example, the clamping elements can be elastically deformable elements which, by being pressed together, realize a non-positive connection between respectively one chain stay and the quick-release axle. Preferably, the clamping elements are partially ring-shaped or ring-shaped and surround the quick-release axle in particular completely. This ensures a uniform power transmission between the chain stays via the clamping elements to the quick-release axle.

In a particularly preferred embodiment, at least one, in particular both clamping elements have a conical outer side and/or a conical inner side. The contact surfaces of the clamping element on the chain stays, in particular a through opening in the chain stays, and on the outer side of the quick-release axle are preferably of complementary design. If both the outer side and the inner side, in particular of the two clamping elements are conical, an axial displacement of the clamping elements can easily realize a clamping connection both with respect to the quick-release axle and with respect to the chain stays.

To simplify assembly, it is preferred that the clamping elements are conical on their outer side and cylindrical on their inner side. This initially allows simple displacement of the clamping elements on the quick-release axle as long as no force has yet been applied to the clamping elements by the at least one adjustment element. In this embodiment of the clamping element, it is preferred if the clamping elements are made of elastically deformable material and/or have a radial slot. Applying the clamping force via the adjustment element thus results in a clamping connection via the conical outer surface of the clamping elements with respect to the conical inner surfaces on the chain stays on the one hand. On the other hand, the deformation, in particular due to the radial slot, results in a reduction of the inner diameter of the clamping elements so that these clamps are fixed to the outer side of the quick-release axle.

The two clamping elements can have different shapes, wherein it is preferred that the two clamping elements have an identical shape.

According to the invention, the embodiment described above can also be used, in particular in a preferred further embodiment, for two rocker stays. The rocker stays are connected to each other with the corresponding components and are mounted to a saddle tube of the bicycle frame in particular in a pivoting manner. A bridge connecting the two rocker stays is not required or can at least be made much thinner and thus lighter. This also significantly reduces the required space.

For the pivoting connection of the two bicycle elements, in particular the two chain stays to a bicycle frame element, the bicycle frame element preferably has a through opening. The quick-release axle is arranged in the through opening. In addition, bearing elements, in particular ball bearings, can be arranged in the through opening. For adjusting and in particular preloading the two ball bearings, it is preferred that one inward-facing side of the two clamping elements acts indirectly or directly on a bearing ring. In this way, the clamping adjustment of the clamping elements with the aid of the adjustment element simultaneously adjusts the bearing clearance or preloads the bearings. A corresponding connection can also be made for rocker stays with a through opening provided in the saddle tube or an extension of the saddle tube.

### BRIEF DESCRIPTION OF THE DRAWINGS

In the following, the invention is described in more detail by means of a preferred embodiment with reference to the accompanying drawings.

In the drawings:

FIG. 1 is a schematic cross-section of a quick-release axle, wherein the illustrated exemplary embodiments shows two chain stays pivotally connected to the bicycle frame element,

FIG. 2 is a schematic perspective view of the preferred embodiment of a clamping element, and

FIG. 3 is a preferred embodiment of a sleeve arranged between the bearings.

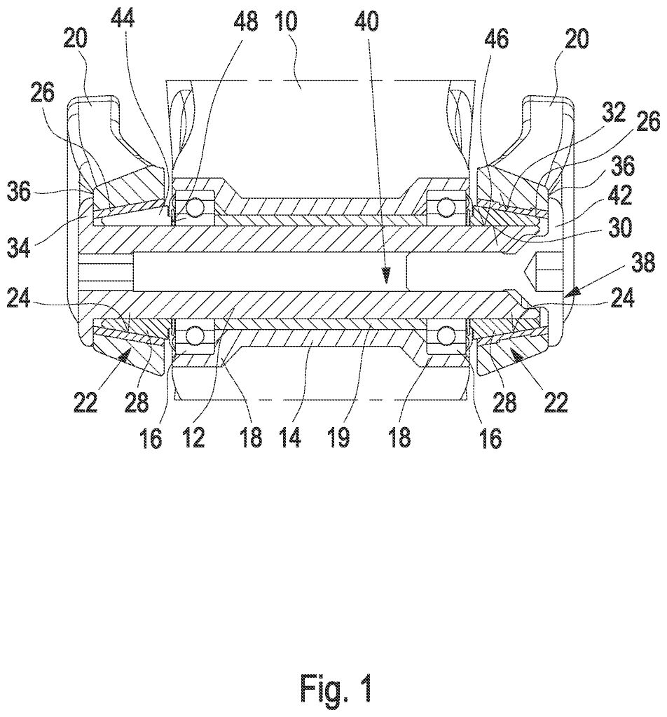

### DESCRIPTION OF THE INVENTION

The quick-release axle system is arranged in a bicycle frame element 10 and comprises a quick-release axle 12. Quick-release axle 12 is arranged in a through opening 14 provided in bicycle frame 10. In the illustrated exemplary embodiment, main link bearings 16 designed as ball bearings are arranged in through opening 14. They are arranged such that a sleeve 19 is arranged between the two inner rings of the two ball bearings 16. The two outer rings of the ball bearings 16 are supported on corresponding extensions 18 of frame element 10. In bicycle frames made of carbon or the like, the extensions 18 are formed by inserts that are firmly connected to the corresponding frame element and are made in particular of aluminum. They are connected to bicycle frame element 10, in particular by co-molding.

A chain stay 20 is arranged on each of the two sides of frame element 10. The two chain stays 20 each comprise a through opening 22. Through opening 22 has a conical inner side 24 widening inwardly, i.e. in the direction of the bicycle frame element 10, wherein a sleeve-like intermediate element 26 made of a corresponding, possibly harder material may be provided. In chain stays 20 made of carbon, the intermediate elements 26 are in turn preferably firmly connected to the chain stays, in particular by co-molding. Here, it is preferred that the intermediate elements 26 are formed as aluminum inserts.

A clamping element 28 is provided in each of the two through openings 22 of the two chain stays 20, the clamping elements 28 being of identical design. The two clamping elements 28 have a cylindrical inner side 30, which is only slightly larger in diameter than the outer diameter of the quick-release axle 12 in this area. Moreover, the two clamping elements 28 have a conical outer side 32, wherein the diameter of the outer side 32 of the clamping elements 28 decreases outwardly to form the conical outer side 32. Thus, conical surface 32 is substantially parallel to the conical inner side 24 of through opening 22 of the chain stays 20.

In the illustrated exemplary embodiment, the quick-release axle comprises a head-shaped extension 34 on the left side in the figure. The head-shaped extension 34 abuts against an outer side 36 of the chain stay 20 on the left in the figure. The quick-release axle is thus inserted from the left for mounting in the figure. An adjustment element 38 is provided on the side opposite the head-shaped extension 34. In the illustrated exemplary embodiment, adjustment element 38 is configured as a screw that engages in a thread provided in an inner bore 40 of quick-release axle 12. Adjustment element 38 also has a head-shaped extension 42 which in turn abuts against an outer side 36 of chain stay 20 on the right in the figure.

Furthermore, in the illustrated exemplary embodiment, the two clamping elements 28 each have a radial slot 44 that extends across the entire width and height of the two clamping elements.

For assembly, the two bearings 16 are first arranged in through opening 14 of frame element 10 together with sleeve 18. The sleeves 26 and the two clamping elements 28 are arranged in the two chain stays 20. Then, quick-release axle 12 is inserted from the left in the figure. For fixation and thus non-positive connection between the chain stays 20 and quick-release axle 12, adjustment element 38 is screwed into inner bore 40. Here, a clamping non-positive connection is effected via the wedge-shaped surfaces 32, 24 and, due to the provision of a slot 44 in the clamping elements 28, a clamping connection is effected between the cylindrical inner side 30 of the clamping elements and a likewise cylindrical outer side 46 of quick-release axle 12.

Since the inner sides 48 of the two clamping elements 28 abut indirectly or directly against the inner rings of the ball bearings 16, the two ball bearings 16 are simultaneously adjusted or preloaded, respectively.

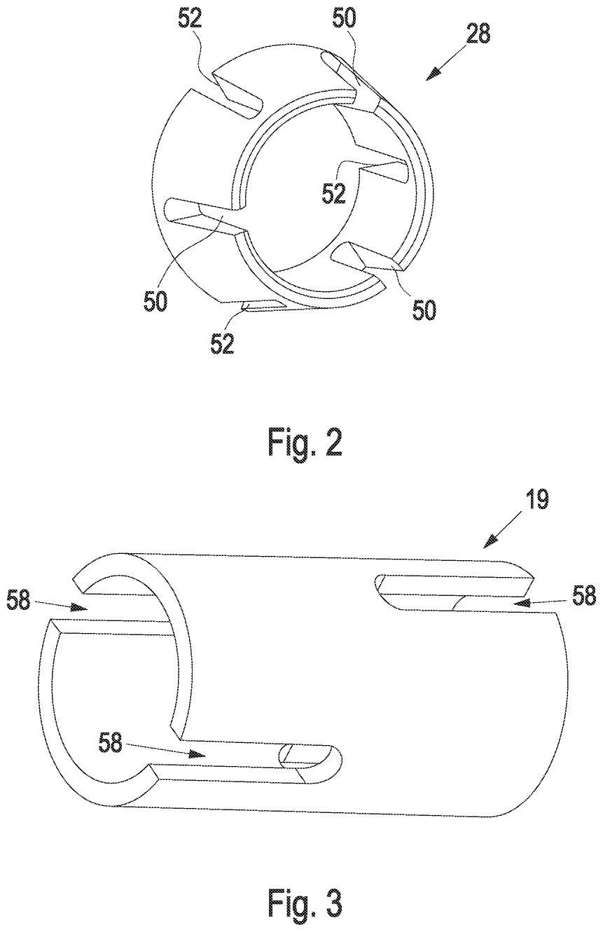

FIG. 2 shows a preferred embodiment of a clamping element 28 in perspective view. Instead of a single radial slot 44, said clamping element comprises multiple slots 50, 52. They each extend in longitudinal direction of clamping element 28 not along the entire length and are open on different opposing sides 54, 56 of clamping element 28. Preferably, there is a regular arrangement of six slots 50, 52, with three slots 50 open toward the inner side 50 and three slots 52 open toward the outer side 54.

FIG. 3 shows a preferred embodiment of sleeve 19. In particular, to facilitate assembly and disassembly, sleeve 19 may have longitudinally extending slots 58 extending inwardly from opposite sides as shown.

1. A quick-release axle system comprising
two bicycle elements, in particular two chain stays, rocker stays or the like,
a quick-release axle connecting the two bicycle elements to each other, and
two clamping elements each arranged between one of the bicycle elements and the quick-release axle, for non-positively connecting the bicycle elements to the quick-release axle.

2. The quick-release axle system according to claim 1, wherein an adjustment element displaceable in the axial direction of the quick-release axle is connected to the quick-release axle.

3. The quick-release axle system according to claim 2, wherein the adjustment element is configured as a screw which can be screwed into an opening of the quick-release axle in particular.

4. The quick-release axle system according to claim 2, wherein the adjustment element comprises an in particular head-shaped extension which cooperates with one of the bicycle elements, in particular abuts against an outer side of the bicycle element.

5. The quick-release axle system according to claim 2, wherein the quick-release axle comprises an in particular head-shaped extension which is opposite the adjustment element and cooperates with one of the bicycle element, in particular abuts against an outer side of the bicycle element.

6. The quick-release axle system according to claim 1, wherein the clamping elements are formed to be wedge- or ring-shaped and in particular completely surround the quick-release axle.

7. The quick-release axle system according to claim 1, wherein an outer side and/or an inner side of at least one of the clamping elements is conical.

8. The quick-release axle system according to claim 7, wherein an inner side of the bicycle elements is formed complementary to the outer sides of the clamping element.

9. The quick-release axle system according to claim 7, wherein an outer side f the quick-release axle is formed complementary to the inner side of the clamping element.

10. The quick-release axle system according to claim 1, wherein the inner side of at least one of the clamping elements is cylindrical.

11. The quick-release axle according to claim wherein at least one of the clamping elements has a radially extending

12. The quick-release axle system according to claim 1, wherein a bicycle frame element having a through opening for receiving the quick-release axle.

13. The quick-release axle according to claim 12, wherein bearing elements, in particular ball bearings, are arranged in the through opening between the quick-release axle and the bicycle frame element
